(19) United States
(12) Patent Application Publication
(10) Pub. No.: US 2014/0141875 A1
(43) Pub. Date: May 22, 2014

(54) Temporary modification for extending functionality of computer games and software applications.

(71) Applicant: Richard Steven Faria, Hitchin (GB)

(72) Inventor: Richard Steven Faria, Hitchin (GB)

(21) Appl. No.: 13/684,214

(22) Filed: Nov. 22, 2012

(51) Int. Cl. A63F 13/12

(52) U.S. Cl. CPC A63F 13/12
USPC 463/29

(57) ABSTRACT

An apparatus comprising:
a processing resource arranged to support a software application, a temporary modification unit, a modifying agent, a monitoring and adjustment controller, and an online and status unit; wherein:
the modifying agent is arranged to send data to and receive data from the monitoring and adjustment controller and to send to and receive data from the temporary modification unit;
the temporary modification unit is arranged to intercept a call from the software application to a function of an API, and to extract software application data and send it to the modifying agent;
the monitoring and adjustment controller is arranged to send data to and receive data from the temporary modification unit, via the modifying agent, in order to change the characteristics of the software application; and
the online and status unit is arranged to receive data from and send data to external sources and pass this data to the monitoring and adjustment controller.

### BACKGROUND TO THE INVENTION

Computer games and applications have been distributed and sold on physical media such as Compact Disks (CD), Digital Versatile Disks (DVD), video game cartridges and a number of other media types based on proprietary formats. As the cost of Internet access and access to other networks has decreased, it has become financially viable for consumers to purchase games on-line by downloading them and using on-line payment systems. Many computer games manufacturers advertise their games by making available images from the computer game, video footage of a computer game being played and a demonstration version of the computer game. The typical difference between the demonstration and full version of a computer game is that the demonstration version only permits a certain portion of the computer game to be played. Demonstration versions are sometimes altered by third parties which adds functionality and in some cases this prohibits the effective sales of other versions.

In computing, a platform describes a framework, either of hardware or software or a combination of both, which allows programs to be executed. A program which is designed for a specific platform is said to target it. Typical platform components include a computer's architecture, operating system, or programming languages and their runtime libraries. A game platform is a specialization of a platform specifically for gaming. Typically a computer game will target one or more game platforms. The process of converting a computer game to target a different platform than that which it was originally designed for is called Porting. Porting can be a difficult and sometimes impossible task for computer games programmers. Many game platform manufacturers ensure a game will only play on their game platform and therefore consumers usually have to purchase multiple game platforms to play different games. In certain cases a consumer who has purchased a game for a particular game platform has to repurchase the same game to play it on a different game platform.

Modern computer games and software applications are growing in their complexity and as a result the size of these computer games and software applications often exceed a size that can conveniently be downloaded. Even demonstration versions of these computer games and software applications often exceed a size that can conveniently be downloaded and many consumers are reluctant to install these demonstration versions as they are usually released at an early stage in the computer game's development cycle and may contain bugs and inaccuracies. Once a demonstration version of a computer game or software application has been installed and a user decides that they wish to un-install it, these bugs and inaccuracies may prevent the un-installation routine from working correctly. This failure to un-install correctly dissuades consumers from installing demonstration computer games and software applications. Additionally because these demonstration computer games and software applications have restricted functionality they are not truly representative of the full version of the computer game or software application.

A number of established protocols are used to enable the streaming of video and audio and are defined here for reference. The Real-time Transport Protocol (RTP) defines a standardized packet format for delivering audio and video over the Internet. The Real-time Transport Control Protocol (RTCP) provides out-of-band control information for an RTP flow. The primary function of RTCP is to provide feedback on the quality of service being provided by RTP. The Real Time Streaming Protocol (RTSP) is a protocol for use in streaming media systems which allows a client to remotely control a streaming media server, issuing VCR-like commands such as “play” and “pause”, and allowing time-based access to files on a server. IP Multicast is a technique to enable a single transmission of packets to be sent over a network and be received at multiple destinations over an IF infrastructure.

It scales to a larger receiver population by not requiring prior knowledge of who or how many receivers there are. Multicast utilizes network infrastructure efficiently by requiring the source to send a packet only once, even if it needs to be delivered to a large number of receivers. The nodes in the network take care of replicating the packet to reach multiple receivers only where necessary. In the fields of packet-switched networks and computer networking, the traffic engineering term Quality of Service (QoS) refers to control mechanisms that can provide different priority to different users or data flows, or guarantee a certain level of performance to a data flow in accordance with requests from the application program. Quality of Service guarantees are important if the network capacity is limited, especially for real-time streaming multimedia applications, for example voice over IF and IP-TV, since these often require a fixed bit rate and may be delay sensitive.

Computer games and software applications have many different software designs and architectures and often use different rendering methods to create the final image that is sent to the monitor for display. A popular rendering method for software applications is a Microsoft API (Application Programming Interface) called GDI (Graphics Device Interface) which is used to create their final display for rendering. Many computer games use a method called DirectX which is a collection of Application Programming Interfaces (APIs) for handling tasks related to multimedia, especially game programming and video, on Microsoft platforms. A game designed to use the DirectX9 APIs cannot be displayed correctly on a computer whose operating system does not include the appropriate DirectX 9 APIs.

### BRIEF SUMMARY OF INVENTION

The present invention provides an apparatus comprising: a processing resource arranged to support a software application, a temporary modification unit, a modifying agent, a monitoring and adjustment controller, and an online and status unit; wherein: the modifying agent is arranged to send data to and receive data from the monitoring and adjustment controller and to send to and receive data from the temporary modification unit; the temporary modification unit is arranged to intercept a call from the software application to a function of an API, and to extract software application data and send it to the modifying agent; the monitoring and adjustment controller is arranged to send data to and receive data from the temporary modification unit, via the modifying agent, in order to change the characteristics of the software application; and the online and status unit is arranged to receive data from and send data to external sources and pass this data to the monitoring adjustment controller.

### Advantages

The present invention extends the original functionality of computer games and software applications enabling them to be used on systems designed for remote operation of games and software applications.

The present invention does not change the original code of the computer game or software application but extends it functionality when it is executed. This leaves the original game or software application code un-altered and for many games and software applications using the present invention, the warrantees granted by the computer game or software application manufacturers will not be affected.

The present invention is compatible with many of the computer games and software applications already published without the manufacturers of these computer games and software applications altering or updating these computer games or software applications.

The present invention enables users to access and use computer games and software applications remotely without having to install these computer games and software applications on remote computers.

The present invention enables graphical and audio content to be overlaid onto the video acquired by a computer game or software application to enable additional graphical information such as the speed of a computer game or software application. This enables the operator, for example, to view a representation of how a computer's hardware resources are affected while it is transmitting video and audio.

The present invention enables graphical and audio content to be overlaid onto the video acquired by a computer game or software application to enable additional graphical information such as web-cam footage. This enables the receiver, for example, to see the owner of the computer that has the game installed.

The present invention enables graphical and audio content to be overlaid onto the video acquired by a computer game or software application to enable additional graphical information to be displayed at the receiver. This information includes but is not limited to information on the performance of the computer that has acquired the game and the network to which it is transmitting details of the game. The operator at the receiver uses this information to manually modify the present invention or the computer game or software application.

The present invention enables the operation of computer games and software applications on devices that have the capability of receiving data suitable for transmission over a network including but not limited to Set Top Boxes and other Digital Media Receivers including those compatible with Universal Plug and Play which will expand the reach of computer games.

The present invention enables a computer game or software application as part of another computer game or software application. This enables computer games and software applications to combine features and displays of different computer games and software applications.

The present invention enables computer games and software applications to be demonstrated without the need to download or install a demonstration version of the computer game and software application. This enables manufacturers of computer games and software applications to have their computer games and software applications tested without the need to distribute demonstration versions of their products. This reduces the risks associated with piracy of computer games and software applications created when demonstration versions are altered to create fully functioning versions.

The present invention enables the deployment of Game on Demand (GoD) or Software on Demand (SoD) services where users do not purchase a computer game or software application but pay a fee to play the computer game or software application. The present invention enables these services to be deployed without having to amend the existing computer game or software application, without the need for bespoke GoD or SoD computer hardware installations and without the need for users to download or install a computer game or software application.

The present invention enables computer games on a particular game platform to be played on a different game platform. An example of this is that the present invention enables a computer game written for the Windows XP platform to be viewed and played on a Sony PlayStation 3 running Linux. This enables consumers who have purchased a game for a particular game platform to only purchase the game once and use the present invention to play the game on other game platforms.

The present invention enables computer games manufacturers and software application manufacturers to write a game or application on a single games platform and offer the present invention for other games platforms. This saves computer games manufacturers the cost of porting computer games or software applications to different platforms.

The ability of the present invention to monitor and dynamically change the required network bandwidth to send video and audio data to a remote user and the ability of the present invention to communicate these requirements to the network owners will make more efficient use of the network used and its bandwidth.

The ability of the present invention to modify the content within a computer game enables the resultant video and audio to be optimised for compression and transmission over a network and makes more efficient use of network bandwidth and traffic for network operators and efficient use of the computer hardware the game is installed on.

### BRIEF DESCRIPTION OF DRAWINGS

An example of the invention will now be described by referring to the accompanying drawings

FIG. 1 is a block diagram of the present invention and how data is captured from a computer game or software application.

FIG. 2 is a preferred configuration for the present invention and how data is captured from a computer game, encoded and prepared for transmission over a network and how keyboard and other data is received.

FIG. 3 is a preferred configuration for a Receiving Device that utilises the present invention via a network and how network packets are received by the Receiving Device, decoded into video and audio and displayed and how keyboard and other data is transmitted.

FIG. 4 is a preferred method of how the present invention is used with an online database and web pages to create a system that enables the remote play and use of games and software applications.

### DETAILED DESCRIPTION OF THE DRAWINGS

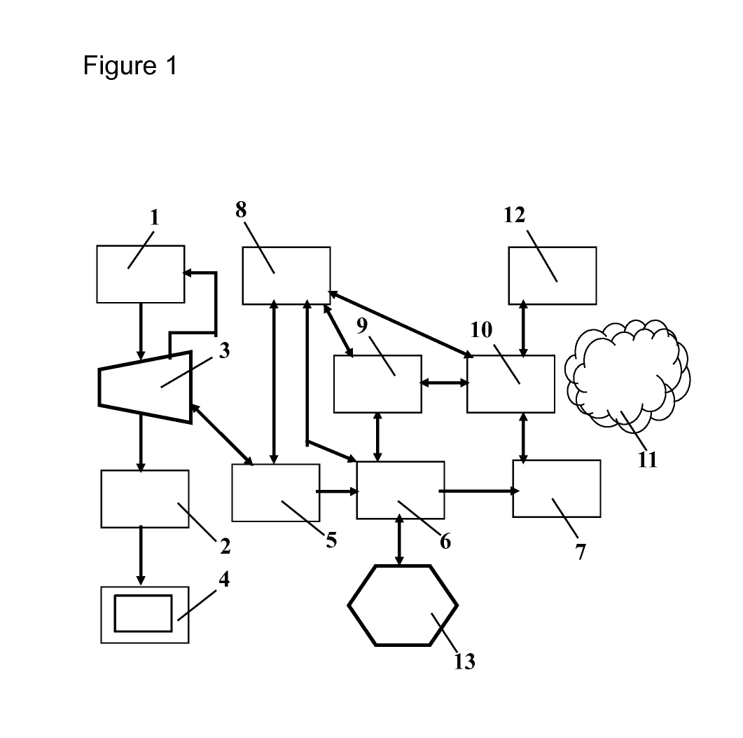

### FIG. 1

As shown in FIG. 1, a Computer Game 1 has been started and its original functionality has been extended by a Temporary Modification 3 which intercepts the games function call to the Graphics API 2 and extracts the games video data and sends a copy of it to a Modifying Agent 5. The games video data is also sent from the Graphics API 2 to a Video Display Unit 4. The video data is sent from the Modifying Agent 5 to a Video Processing Unit 6. The Video Processing Unit 6 uses Video Processing Algorithms 13 and selects an algorithm to modify the video and then modifies the video to a format suitable for transmission via a Network Transmitter 7 and then onto the Network 11. A Monitoring and Adjustment Controller 8 sends and receives data from the Temporary Modification 3 via the Modifying Agent 5. This data is used to control and adjust the characteristics of the game and the characteristics and details of the Graphics API 2 used by the Temporary Modification 3. A Monitoring and Adjustment Controller 8 controls the characteristics of the Video Processing Unit 6. A Monitoring and Adjustment Controller 8 controls the characteristics of a Security Unit 9. A Monitoring and Adjustment Controller 8 controls the characteristics of a Security Unit 9. A Monitoring and Adjustment Controller 8 controls the characteristics of an Online Status and Communications Unit 10. This Online and Status Unit 10 is used to communicate with outside systems including but not limited to an online database and network provider. The Security Unit 9 enables data to be encrypted and decrypted in the Video Processing Unit 6. The Security Unit 9 enables data to be encrypted and decrypted by the Online Status and Communications Unit 10. The Online Status and Communication enables data to be monitored and encrypted and decrypted by the Network Transmitter 7 and the Network Receiver 12. The Online Status and Communications Unit 10 communicates with a remote device or facility and sends it details of status and modifications made by the Monitoring and Adjustment Controller 8. Data from a remote device or facility is received over the Network 11 and then to the Network Receiver Unit 12 which passes this data to the Online Status and Communications Unit 10 which then sends it to the Monitoring and Adjustment Controller 8.

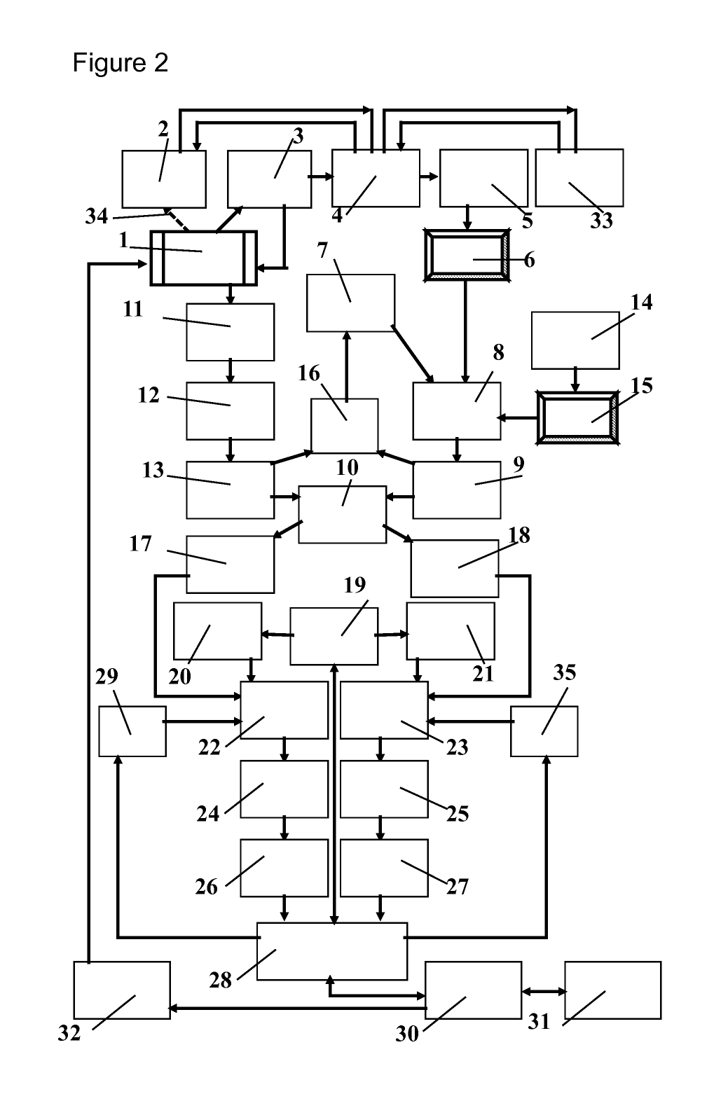

### FIG. 2

As shown in FIG. 2, a Computer Game 1 has been activated and a Game Modifying Agent 3 intercepts the Connection 34 between the Computer Game 1 and the Graphical Application Program Interface (API) 2. The Computer Game 1 issues a command to begin drawing which is intercepted by the Game Modifying Agent 3 and then passed to the Graphics Server 4. The Computer Game 1 then issues drawing commands to the Graphical API 2 and when the Computer Game 1 has finished drawing it issues a final command to signify that the drawing should be displayed which is intercepted by the Game Modifying Agent 3 and then processed by the Graphics Server 4. In response to this the Graphics Server 4 communicates with the Graphical API 2 and retrieves the graphical image into the Colour Space Converter 5 which modifies the image and outputs to the Shared Memory Frame Buffer 6. Before the Graphics Server 4 completes the command to display the image of the Computer Game 1 it notifies the External Graphics Module 33 to allow the External Graphics Module 33 to pass additional commands to the Graphics Server 4 which are then passed to the Graphical API 2. The Graphics Server 4 then completes the display command.

The Video Production Controller 7 instructs the Video Compositor 8 to retrieve an image from the Shared Memory Buffer 6 and composite it with the contents of the External Overlay Frame Buffer 15. Additional video and images are transferred to the External Overlay Frame Buffer 15 by the External Image System 14. The image is transferred from the Video Compositor 8 to the Capture Output Filter 10 via a Sample Timing Capture Filter 9. The Computer Game 1 produces audio which is sent to the computers Audio System 11. The audio data is retrieved from the audio system by the Audio Capture Filter 12 and is passed to the Capture Output Filter 10 via a Sample Timing Capture Filter 13. The Sample Timing Capture Filter 9 and 13 monitor the timing of the incoming data stream. This information is fed to the Synchronisation Controller 16 which processes this information and uses it to control the rate of production of video by the Video Production Controller 7. The control of the rate of production of video enables video and audio synchronisation to be re-established in the event of slow production caused by, but not limited to, CPU over usage and network availability.

The Capture Output Filter 10 directs the image to the Video Encoder 18 and audio samples to the Audio Encoder 17. The encoders 17 and 18 generate packets of encoded data and these are transferred to a Framed Media Source 22 and 23. The Framed Media Source 22 and 23 decides how the encoded data is divided into packets that are compatible with Real Time Protocol (RTP). The encoded data and information of how to divide the encoded data is used RTP Framer 24 and 25 to create one or more RTP packets. Each RTP packet is held at the RTP Sink 26 and 27. The RTP Sink 26 and 27 signal the Server IO Scheduler 28 when a packet is ready. The Server IO Scheduler 28 then sends the packet via the Network Subsystem 30 to the Network 31. The Server IO Scheduler 28 receives from the Network 31 Real Time Control Protocol (RTCP) control messages that are then sent back to the Framed Media Source 22 and 23 via the RTCP Control Channel 29 and 35. This RTCP information is used to maintain the quality of services between the transmission system and the receiving system.

The Server IO Scheduler 28 receives Real Time Streaming Protocol (RTSP) commands from the Receiving Device and uses these to report or modify various settings of the present invention including but not limited to the activation and configuration of the Capture Media Session 19, the parameters of Audio Encoder 17 and Video Encoder 18.

In certain circumstances the network connection between the present invention and the receiving device may actually be terminated and is such circumstances the present invention and the receiving device will re-synchronise themselves by the present invention pausing the transmission of video and audio data.

If required, the Computer Game 1 has its contents adjusted by the Game Modifying Agent 3 to ensure that the resultant video and audio generated by the Computer Game 1 and graphics system is optimised for the Audio Encoder 17, the Video Encoder 18 and the network bandwidth available.

The Audio Encoder 17 and Video Encoder 18 are monitored and their parameter settings are dynamically adjusted so that the resultant compressed audio and video data is optimised for the video produced by the Computer Game 1 and the graphics system and the network bandwidth available. Factors that determine the parameter settings include but are not limited to CPU usage, the available network bandwidth and the frame rate at which the computer game plays.

Where the data produced by the present invention exceeds or is less than the network bandwidth available, the RTP Sink 26 and 27 informs the Server IO Scheduler 28 that the network bandwidth should be adjusted. The Scheduler IO Server 28 relays this information to the network supplier via the Network Subsystem 30 and the Network 31 to enable the available network bandwidth to be adjusted. A Human Interface Module 32 receives data from the receiving device via the Network 31 and the Network Subsystem 30 and sends this data back to the Computer Game 1.

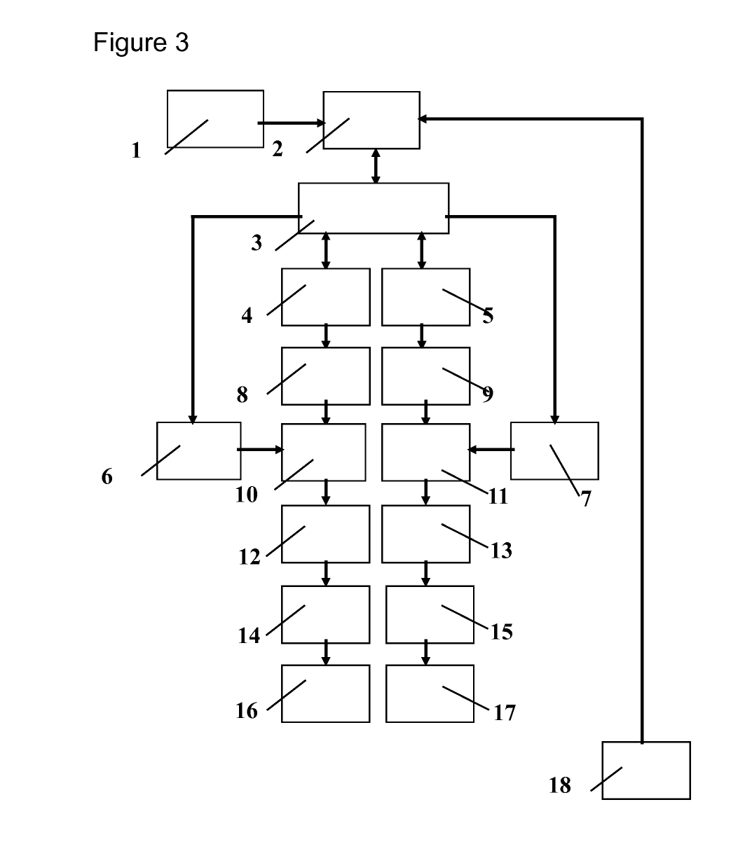

### FIG. 3

As shown in FIG. 3, RTP packets are received via the Network 1 to the Network Subsystem 2 and are retrieved by the Server IO Scheduler 3. The Server IO Scheduler 3 routes the RTP audio and video data to the appropriate RTP Source 4 and 5 and the RTCP data to the appropriate RTCP channel 6 and 7. The RTP Source 4 and 5 then passes the data to an RTP Framer 8 and 9. The RTP Framer 8 and 9 and the Framed Media Source 10 and 11 take the discrete packets of RTP data and arrange them into a packet of encoded data for Audio Decoder 12 and the Video Decoder 13. The Audio Decoder 12 and the Video Decoder 13 then decode the data and pass the decoded data to the Audio Renderer 14 and the Video Renderer 15. The audio and video data is then passed to the Audio System 16 and the Graphics API 17 of the receiving computer. Keyboard and other Human Interface Device data is captured by the HID Capture Module 18 and this data is sent via the Network Subsystem 2 to the Network 1 and from here back to the present invention.

RTSP commands are sent from the Server IO Scheduler 3 via the Network Subsystem 2 to the Network 1 to the present invention. These commands include but are not limited to start and stop commands, details of the receiver parameter settings, synchronisation information and information on the video quality achieved at the GR.

In certain circumstances the network connection between the present invention and the receiving device may actually be terminated and is such circumstances the present invention and the receiving device will re-synchronise themselves by the receiving device discarding video and audio data that is no longer required.

The Audio Decoder 12 and Video Decoder 13 are monitored and their parameter settings are dynamically adjusted so that the resultant decompressed audio and video data is optimised for playback on the receiving device. Factors that determine the parameter settings include but are not limited to CPU usage and frame rate of the of the received video and audio.

Where the video and audio data received exceeds or is less than the network bandwidth available, the RTP Source 4 and 5 informs the Server IO Scheduler 3 that the network bandwidth should be adjusted. The Scheduler IO Server 3 relays this information to the network supplier via the Network Subsystem 2 and the Network 1 to enable the available network bandwidth to be adjusted.

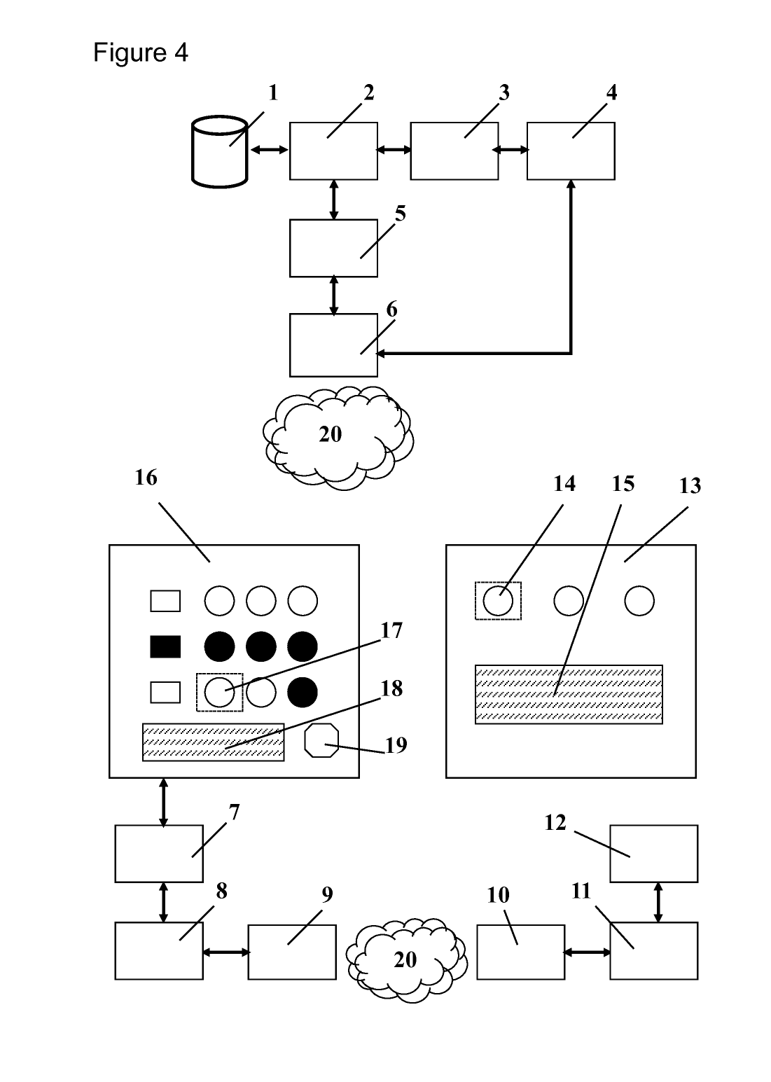

### FIG. 4

FIG. 4 shows a Database 1 which is connected via a Database Interface 2 to a Common Gateway Interface 3 which produces Web Pages 4. The Database Interface 2 is also connected to Security Layer 5 that connects to a Networking Transceiver 6 and to the Network 20.

A user opens up a Web Page 13 on the Network 20 and enters details about their Computer Game 12 and this is displayed as Part of a Web Page 14. They also enter the location of the game on their hard drive 15.

Another user opens a Web Page 16 on the Network 20 and selects a Game 17 they edit the parameters 18 which control the parameters of the data they want to receive. They select The Link 19 which contains a symbolic identifier link to the details of the game in the Database 1. The Link 19 is associated with their Web Browser to their Receiver 8. When The Link 19 is selected the association launches the Receiver 8's user interface. The parameters contained in The Link 19 are passed to the Receiver 8.

Receiver 8 contacts the Database 1 via the Network Transceiver 9 and via the Network 20 and via the Network Transceiver 6 and via the Security Module 5 and via the Database Interface 2 and passes it a unique identifier and details of The Link 19 to the Database 1. The Database 1 checks the Receiver 8 unique identifier and that the Receiver 8 has been given permission to access The Present Invention 11. The Database 1 then creates a Service Ticket containing the unique identifier of the Receiver 8 and a unique identifier for The Present Invention 11. The database sends the Receiver 8 the network address of The Present Invention 11 and a unique identifier. The Receiver 8 sends The Present Invention 11 the unique identifier via the Network Transceiver 9 and via the Network 20 and via the Network Transceiver 10. The Present Invention 11 checks the Receiver has permission with the Database 1 via the Network Transceiver 10 and via the Network 20 and via the Transceiver 6 and via the Security Layer 5 and via the Database Interface 2.

The Database 1 checks that both Receiver 8 and The Present Invention 11 have permission to exchange data. The Database 1 sends The Present Invention 11 details of the resolution, bandwidth and other data it is to use to send video and audio to the Receiver 8. The Present Invention 11 starts the Game 12 and modifies it extracting its video and audio, converting it into a format suitable for transmission and sending it via the Network Transceiver 10 and over the Network 20 to the Network Transceiver 9 to the Receiver 8 which then displays the video and audio from the game. Keyboard commands are collected by the Receiver 8 and sent back via the Transceiver 9 over the Network 20 to Network Transceiver 10 and to The Present Invention 11. The Present Invention 11 sends these keyboard commands back to the Game 12. The Database 1 monitors the Receiver 8 and The Present Invention 11 and modifies the data sent between them to ensure that the Receiver 8 displays the optimum picture quality.

### DETAILED DESCRIPTION OF THE INVENTION

The present invention provides an apparatus comprising: a processing resource arranged to support a software application, a temporary modification unit, a modifying agent, a monitoring and adjustment controller, and an online and status unit; wherein: the modifying agent is arranged to send data to and receive data from the monitoring and adjustment controller and to send to and receive data from the temporary modification unit; the temporary modification unit is arranged to intercept a call from the software application to a function of an API, and to extract software application data and send it to the modifying agent; the monitoring and adjustment controller is arranged to send data to and receive data from the temporary modification unit, via the modifying agent, in order to change the characteristics of the software application; and the online and status unit is arranged to receive data from and send data to external sources and pass this data to the monitoring adjustment controller.

There is thus provided in accordance with a preferred example of the present invention a system that extends the original functionality of a computer game or software application program when it is executed so that the computer game's or software application's graphical and audio data is acquired and converted to a format suitable for transmission over a network to enable the remote display and operation of these computer games and software applications.

The present invention modifies the computer game or application code when it is executed without altering the original computer game or software application code. The present invention modifies the original computer game or software application code of computer games and software applications installed on computer hard drives, or stored on hard drives, DVD disks, other disk based media or solid state memory.

A preferred example intercepts the computer game's or software application's communication with the graphic's APIs and uses the graphic's APIs to retrieve the computer game's or software application's graphical data which a preferred example then converts to a suitable format for transmission. A computer game or software application consists of binary code which instructs a computer processor to perform operations. The binary code is loaded into a computers memory and the instructions are executed sequentially by the computer processor or in parallel if the computer has multiple processors. The location in the computers memory of the next instruction to execute is called the instruction pointer. As the computer game or software application executes the instruction pointer progresses through sections of instructions called functions. If during a function the instruction pointer is directed to another function this is called a function call. When a function has completed it directs the function pointer to the address immediately following the instruction which called it.

When a computer game or software application renders 3D graphics it will call functions which are provided by the Operating System in the form of graphics APIs.

The present invention replaces the start of these functions with calls to its own functions which modify the operation of the computer game or software application and enable the graphical output to be manipulated and obtained. A disclosed example analyses the size and characteristics of this graphical output and the characteristics of the chosen network and converts the graphical output into a format suitable for transmission. A preferred example dynamically changes the characteristics of its operation by analysing characteristics and accepting feedback from the computer game's or software application's contents, the graphical and audio data obtained from the computer game or software application, the characteristics and any feedback information provided by the network or data from a system that has been modified to utilise the present invention.

According to another disclosed example the computer game's or software application's audio data is acquired and converted to a format suitable for another system such as a system that provides the remote operation of games and applications. An example obtains audio data from the game or software application by using audio services provided by the operating system. A preferred example maintains synchronisation between video and audio data acquired from the computer game or software application and, if required, dynamically adjusts the characteristics of the audio data prior to transmission including but not limited to adjustment of the audio bandwidth, compression ratio and bit rate.

According to another disclosed example the computer game's or software application's input and output data from keyboards, mouse and other control data are replaced or appended with keyboard, mouse or control data from a remote device or remote system. A disclosed example provides keyboard, mouse and control data to the game or software application from local or remote systems by using the operating system keyboard, mouse and control data input services. Keyboard, mouse and control data is collected from a remote location and sent via a network to a present example which sends this data to the computer game or software application. A present example thus enables both local and remote control of the computer game or software application. The modification, both dynamically and non-dynamically, is used to improve the quality or characteristics of the data the present invention creates or modifies including but not limited to video quality and bandwidth.

The modification, both dynamically and non-dynamically, is used to improve the quality or characteristics of the data the present invention creates or modifies including but not limited to video quality and bandwidth.

Feedback is provided to systems that use the present invention to improve their efficiency of operation and the quality of the video transmitted. Such feedback includes but is not limited to computer hardware status data, prior notifications of network bandwidth requirements and game metadata.

Modification, both dynamically and non-dynamically, of the features and characteristics of the video, audio, keyboard data, mouse data, control data and metadata or any other data generated by the computer game or software application including but not limited to size, resolution, video or audio format, data rates, refresh rates, meta data and any other characteristic is used to ensure that the experience of a user operating the computer game or software application locally is as similar as possible to the experience of operating the computer game or software application from a remote location.

Modification, both dynamically and non-dynamically, of the contents of a computer game or software application and the characteristics of content used including but not limited to video, audio, meta data, meta data format, text, colour palette, the polygonal complexity of the 3D objects or digital compression algorithm is used to ensure that the experience of a user operating the computer game or software application locally is as similar as possible to the experience of operating the computer game or software application from a remote location.

Modification, both dynamically and non-dynamically, of the characteristics and details of which API is used to extend the original functionality of computer game or software application is used to obtain the highest quality graphical and audio quality. Such modifications ensure that the experience of a user operating the computer game or software application locally is as similar as possible to the experience of operating the computer game or software application from a remote location.

The modification, both dynamically and non-dynamically, of the characteristics and details of the data generated by disclosed examples prior to it being sent over a network to ensure the experience of a user operating the computer game or software application locally is as similar as possible to the experience of operating the computer game or software application from a remote location. If required, the data sent over the network is encrypted prior to transmission.

Communication to instruct the modification of present examples from computer operating systems, computer games, software applications, databases, operating systems or other systems is provided and if required present examples encrypt this communication.

Modification, both dynamically and non-dynamically, of the network's bandwidth and routing information required is determined and communicated to the network owner to improve the network's Quality of Service.

The modification, both dynamically and non-dynamically of the characteristics of the data sent by present examples is used in conjunction with data from the receiving device to ensure the experience of a user operating the computer game or software application locally is as similar as possible to the experience of operating the computer game or software application from a remote location.

Commands to instruct the execution of computer games and software applications installed on the computer on which the present invention is installed are instigated from a user at this location or by remote instructions via a network.

Commands to instruct the termination of computer games and software applications installed on the computer on which the present invention is installed are instigated from a user at this location or by remote instructions via a network.

There is also disclosed a system that extends the functionality of the game or application by making a permanent change to the game or application software prior to it being executed so that its graphical output is acquired in a format suitable for transmission and remote display.

There is also disclosed a system that extends the original functionality of the game or application program when it is executed so that its graphical output and, if required, its audio, keyboard, mouse, control and metadata output is acquired for archiving to a storage medium.

There is also disclosed a system that extends the original functionality of the game or application program when it is executed so that its graphical output is overlaid with graphical information including but not limited to a graphical representation of the computer game's or software application's speed in frames per second (FPS), the API used to acquire the game, images and video from files stored locally, speed of the transmission, quality of video, live video from web cams, other video sources such as operating system API's and adverts.

There is also disclosed a system that extends the original functionality of the game or application program when it is executed so that its audio output is mixed with audio information including but not limited to audio from files stored locally, live audio from microphones, audio from web cams, other audio sources such as operating system API's and adverts.

A disclosed system enables real-time monitoring and dynamic adjustment of the computer game or software application. This monitoring system is used to ensure that an acceptable picture and audio quality is maintained and that network bandwidth is optimised and where necessary adjusted to achieve an acceptable Quality of Service.

There is also disclosed a method to change the format created by preferred examples to IP multicast packets to enables a number of receivers to view and hear the computer game or software application simultaneously or as near to simultaneously as the network utilised will allow.

Preferably, digital media receivers such as set top boxes supplied by cable and satellite companies are used as receiving devices to display computer game and software application data including but not limited to UPnP enabled devices.

There is also disclosed a system that shares the use of computer games and software applications via an Internet site, online database or other online graphical portal (Website). Users form groups on the Website and share details of their computer games or software applications including representations of the network location of the computers. Users utilise this Website to access and play other members games and software applications remotely and to offer other members remote access and play to their own computer games and software applications.

1. An apparatus comprising:
a processing resource arranged to support a software application, a temporary modification unit, a modifying agent, a monitoring and adjustment controller, and an online and status unit; wherein:
the modifying agent is arranged to send data to and receive data from the monitoring and adjustment controller and to send to and receive data from the temporary modification unit;
the temporary modification unit is arranged to intercept a call from the software application to a function of an API, and to extract software application data and send it to the modifying agent;
the monitoring and adjustment controller is arranged to send data to and receive data from the temporary modification unit, via the modifying agent, in order to change the characteristics of the software application; and
the online and status unit is arranged to receive data from and send data to external sources and pass this data to the monitoring and adjustment controller.

2. An apparatus as claimed in claim 1, wherein the software application is a game.

3. An apparatus as claimed in claim 1 or claim 2, wherein one of the characteristics is the polygonal complexity of 3D objects used in the software application.

4. An apparatus as claimed in claim 1 or claim 2 or claim 3, wherein one of the characteristics is the colour palette used in the software application.

5. An apparatus as claimed in any preceding claim, wherein one of the characteristics is the audio data used in the software application.

6. An apparatus as claimed in any preceding claim, wherein one of the characteristics is the video data used in the software application.

7. An apparatus as claimed in any preceding claim, wherein one of the characteristics is the metadata used in the software application.

8. An apparatus as claimed in any preceding claim, wherein one of the characteristics is the metadata format used in the software application.

9. An apparatus as claimed in any preceding claim, wherein one of the characteristics is the text used in the software application.

10. An apparatus as claimed in any preceding claim, wherein one of the characteristics is the digital compression algorithm used within the software application.
